(19) United States
(12) Patent Application Publication
(10) Pub. No.: US 2024/0342928 A1
(43) Pub. Date: Oct. 17, 2024

(54) GRIPPING TOOL

(71) Applicant: Festo SE & Co. KG, Esslingen (DE)

(72) Inventor: Markus AEGERTER, Altbach (DE)

(21) Appl. No.: 18/631,751

(22) Filed: Apr. 10, 2024

(30) Foreign Application Priority Data
Apr. 11, 2023 (DE) 10 2023 109 022.4

(51) Int. Cl. B25J 15/10

(52) U.S. Cl. CPC B25J 15/10

(57) ABSTRACT

A gripping tool which has a gripper finger carrier extending along a center axis and carrying a plurality of gripper fingers which are distributed around the center axis and can be swiveled by means of an actuating device based on a magnetic operating principle for selectively gripping or releasing an object. A special feature is that the gripper fingers are arranged as separate components on one-piece leaf spring clips with spring-elastic properties, which are each attached via an outer clip section to the gripper finger carrier and via an inner clip section to a drive element that can be driven to swivel the gripper fingers to a drive movement.

This application claims priority to German Patent Application No. 10 2023 109 022.4 filed Apr. 11, 2023, which is incorporated by reference.

### SUMMARY OF THE INVENTION

The invention relates to a gripping tool with a gripper finger carrier extending along a center axis and a plurality of gripper fingers arranged on the gripper finger carrier distributed around the center axis, wherein the gripper fingers can be driven synchronously by an actuating device based on a magnetic operating principle either for an inward swivel movement oriented inwards in the direction of the center axis or for an outward swivel movement oriented outwards away from the center axis, wherein each gripper finger is attached via a movable first suspension arm to the gripper finger carrier and via a movable second suspension arm to a drive element of the actuating device, wherein the drive element can be driven by the action of magnetic forces relative to the gripper finger carrier to perform a reciprocating drive movement in the axial direction of the center axis, from which either the inward swivel movement or the outward swivel movement of the gripper fingers results, depending on the direction of movement of the drive element.

A gripping tool of this type known from DE 10 2019 119 125 A1 has several gripper fingers arranged distributed around a center axis, each of which is arranged on a sleeve-shaped gripper finger carrier so as to be elastically bendable over a section of reduced cross-section and is fixed in an articulated manner via a fixing bar to an anchor plate acting as a drive element. The anchor plate is part of an actuating device based on a magnetic operating principle, which has a switchable coil through which a magnetic field can be generated in order to bring about an inward swivel movement approaching the center axis or an opposite outward swivel movement of the gripper fingers. In this way, any objects can be gripped and repositioned.

DE 10 2019 206 097 A1 discloses a gripping tool that has several pivoting gripping elements that can be pivoted by means of a permanent-magnetic actuating device in order to selectively grip or release an object.

The invention is based on the task of creating a gripping tool which can be actuated using a magnetic operating principle and which ensures reliable operation with a simple and cost-effective design.

To solve this problem, in conjunction with the features mentioned at the beginning, it is provided that each gripper finger is arranged as a separate component on at least one one-piece leaf spring clip which has resilient properties and which has an outer clip section forming the first suspension arm and an inner clip section forming the second suspension arm, the outer and inner clip sections being able to bend resiliently during the drive movement of the drive element with the gripper fingers being entrained.

The gripping tool according to the invention contains a plurality of gripping structures distributed around a center axis, which can be designated as gripper arms and which each contain at least one one-piece leaf spring clip and a gripper finger attached to this at least one leaf spring clip as a separate component.

The gripper fingers can be attached to a single leaf spring clip or—especially if higher spring forces are required—to several leaf spring clips arranged next to each other. Each gripper finger is fixed to the gripper finger carrier on the one hand and to the drive element on the other via the spring clip supporting it, whereby a drive movement of the drive element results in a spring-elastic deformation of the leaf spring clip, which is accompanied by a gripper finger swivel movement which, depending on the direction of movement of the drive element, is an inward swivel movement in the direction of the center axis or an outward swivel movement in the opposite direction. The gripper finger is coupled to the gripper finger carrier via a spring-elastic outer clip section of the leaf spring clip, while the coupling to the drive element takes place via an inner clip section of the leaf spring clip, which is also spring-elastic. The gripper finger is suitably attached to the leaf spring clip between these two clip sections. The division of the gripper arms into an overall resilient leaf spring clip and a separate gripper finger attached to it enables cost-effective manufacture and reliable operation due to extremely low susceptibility to wear. When manufacturing the gripping tool, object-specific requirements can easily be taken into account by equipping standard leaf spring clips with individually adapted gripper fingers. Actuation based on a magnetic operating principle allows extremely low-friction operation with relatively low drive forces, so that the gripping forces can be finely dosed for gentle gripping processes and energy consumption is low.

Advantageous further embodiments of the invention are shown in the sub-claims.

Although the leaf spring clips can in principle be made of a plastic material, it is more advantageous for reasons of fatigue strength if each leaf spring clip is made of spring steel. Preferably, each leaf spring clip has a finger attachment section to which the associated gripper finger is attached, and which can have a correspondingly designed attachment interface for this purpose. The finger attachment section merges integrally into the two leaf spring clips, via which it is fixed to the gripper finger carrier and the drive element.

Preferably, the finger attachment section is narrower than at least the adjoining length section of the outer clip section. In addition, the finger attachment section is preferably wider than at least the adjoining length section of the inner clip section.

In a preferred embodiment, the finger attachment section of each leaf spring clip has an inclined alignment with respect to the center axis. It merges into the inner clip section at an angle in an inner clip transition region and into the outer clip section at an angle in an outer clip transition region. Starting from the outer clip transition region, the outer clip section extends at a radial distance from the center axis in the direction of the fastening interface on the gripper finger carrier. The inner clip section extends from the inner clip transition region at an angle to the center axis to the fastening interface on the drive element.

The gripper fingers can either be detachably or non-detachably attached to the respective leaf spring clip. A detachable design allows the fingers to be replaced as required, for example to convert the gripping tool for different gripping tasks. A detachable attachment can be realized, for example, via a snap-in connection device that enables clipping or via a screw connection device. Non-detachable fastening is particularly cost-effective and can be achieved, for example, by inserting fastening pins arranged on the gripper finger, in particular made of plastic, through holes in the leaf spring clip and then caulking them, in particular by applying heat.

The gripper fingers are preferably made of a plastic material. The gripper fingers are preferably designed in one piece, but can also be designed in several parts, for example in order to realize object-specific gripping contours particularly easily. For example, each gripper finger can have a base section used to fix it to the leaf spring clip and a gripping section attached to it that defines the gripping contour. The base section and gripping section can be designed as a two-component injection-molded part, for example.

The outer clip section of each leaf spring clip is conveniently attached to the gripper finger carrier via an outer attachment end section. The outer attachment end section can be designed very simply for an easy-to-handle and reliable fastening method.

Preferably, a groove-like retaining recess is formed on the outer circumference of the gripper finger carrier as a fastening interface for each leaf spring clip, into which the outer attachment end section plunges. A fastening pin projecting from a base surface of the retaining recess protrudes into a fastening hole in the outer attachment end section so that the leaf spring clip is held positively in the axial direction of the center axis. The outer attachment end section is supported at its two side edges by lateral boundary surfaces of the retaining recess, so that exact parallelism to the center axis can be ensured. Accidental removal from the fastening pins is prevented by the fact that the outer attachment end section is bridged by a fixing bar arranged on the gripper finger carrier, which supports the outer attachment section in a radial direction in relation to the center axis.

The fixing bar is preferably an integral part of the gripper finger carrier and is designed, for example, in the form of a tab at one end region of the holding recess. In addition or alternatively, the fixing bar can be a component of a fixing ring that is separate from the gripper finger carrier, which is placed on the gripper finger carrier coaxially to the center axis and, for example, plugged on. The fixing ring is pressed on or glued on, for example. For fastening to the drive element, the inner clip section of each leaf spring clip is equipped with an inner attachment end section at its end region opposite the associated gripper finger. The inner attachment end section is preferably designed for detachable fastening to the drive element, which has a suitable fastening interface for this purpose, for example at least one fastening hole.

In a convenient embodiment, the inner attachment end section of each leaf spring clip has a fastening eye through which a fastening element passes to secure it to the drive element. The fastening element can be a fastening bolt or a fastening screw, for example. If, in a preferred embodiment, several leaf spring clips are combined to form a one-piece clip unit, the leaf spring clips can have a common inner attachment end section.

Each leaf spring clip extends with a non-linear longitudinal course in a longitudinal direction between opposing attachment end sections. Each leaf spring clip has a certain width in a width direction transverse to its longitudinal direction and a smaller thickness in a thickness direction orthogonal to the width direction. The leaf spring clip is elastically deformable in a plane orthogonal to the width direction. The thickness of the leaf spring clip is suitably constant over its entire length. Preferably, none of the leaf spring clips has a section of reduced thickness defining a solid body joint. Each leaf spring clip is appropriately designed without a joint over its entire length, so that the mobility of the gripper fingers results exclusively from the spring elasticity of the leaf spring clip, at least in the regions of the inner and outer clip section.

Preferably, the inner clip section of each leaf spring clip has a smaller width than the outer clip section, at least in a length section adjoining the associated gripper finger.

The gripping tool can have an even number or an odd number of gripper fingers and leaf spring clips. For better differentiation, any combination of a gripper finger and at least one leaf spring clip can also be referred to as a gripper arm.

For example, the gripping tool can have three gripper arms that are arranged at angular intervals of 120 degrees around the center axis.

In the case of a gripping tool with an even number of gripper arms, the gripper fingers and the associated leaf spring clips are conveniently positioned opposite each other in pairs orthogonally to the center axis. In this way, the leaf spring clips form at least one spring clip pair consisting of two leaf spring clips lying opposite each other transversely to the center axis and in a common spring clip pair plane. In this way, two gripper arms or two gripper fingers lie opposite each other in a diametrical direction with respect to the center axis. Each leaf spring clip is elastically bendable in the spring clip pair plane.

In a cost-effective design, the gripping tool can have just two gripper fingers. However, a particularly secure gripping result is achieved if there are two pairs of gripper fingers diametrically opposite each other in relation to the center axis, with the four gripper fingers arranged at angular intervals of 90 degrees around the center axis.

It is particularly advantageous if the gripping tool has four leaf spring clips, which are arranged to form two pairs of spring clips, whereby the leaf spring clips of each pair of spring clips lie opposite each other orthogonally to the center axis.

In a practical embodiment, the two pairs of spring clips are arranged in a crossover configuration with the spring clip pair planes perpendicular to each other, whereby each leaf spring clip is attached to the gripper finger carrier via its outer clip section and to the drive element via its inner clip section.

In an alternative embodiment, four leaf spring clips form two pairs of spring wings that are arranged in a side-by-side configuration with parallel spring clip pair planes, with each leaf spring clip being attached to the gripper finger carrier via its outer clip section and to the drive element via its inner clip section. In this embodiment, only a single gripper finger is preferably arranged on the leaf spring clips belonging to different pairs of spring clips and arranged next to each other. Two leaf spring clips then each carry only a single gripper finger and together with this gripper finger form a gripper arm.

Particularly cost-effective production is possible if the two leaf spring clips of each pair of spring clips are firmly connected to each other at their inner clip sections, so that the pair of spring clips in question forms an integral spring clip unit. The spring clip pairs can, for example, be welded together or attached to each other by material deformation. A one-piece design of the respective spring clip unit is particularly practical.

The leaf spring clips of each pair of spring clips and in particular of each spring clip unit conveniently have a common inner attachment end section for fixing to the drive element. The gripping tool is conveniently equipped with a base body in which a drive unit of the actuating device, which cooperates magnetically with the drive element to generate its drive movement, is accommodated.

Preferably, the drive unit is designed to provide at least one magnetic field that is capable of selectively exerting magnetic drive forces on the drive element to cause the drive movement of the drive element. This can manifest itself in the imposition of magnetic forces of varying strength through to the complete removal of magnetic forces. Preferably, the drive element has magnetizable properties, whereby it is conveniently made of a ferromagnetic material, so that it can also be referred to as an anchor element, for example. Preferably, the drive element has no permanent magnetic properties, although this would also be possible in principle.

In a particularly practical embodiment, the drive unit contains a permanent magnet providing a permanent magnetic field and an electrically energizable coil. By energizing the coil, a coil magnetic field superimposed on the permanent magnetic field can be generated in order to influence the magnetic drive forces acting on the drive element. For example, this can be used to ensure that either a magnetic field attracting the drive element is present or that there is no magnetic field or only a weaker magnetic field acting on the drive element.

By specifying the corresponding operating state of the actuating device, the gripper fingers can be positioned either in a closed position brought close to the center axis by the inward swivel movement or in an open position away from the center axis by the outward swivel movement. The actuating device is preferably designed so that the open position with the coil deactivated is held stable by the spring forces of the leaf spring clips and the closed position with the coil deactivated is held stable by the permanent magnetic field. This results in a bistable gripping function. The actuating device conveniently contains a switching device that enables the coil to be energized with opposing current directions, so that a coil magnetic field that weakens or strengthens the permanent magnetic field can be generated as required to switch the gripper fingers between the open position and the closed position.

Alternatively, the gripping tool can have a monostable gripping function, for example. In this case, the gripper fingers are preferably held in the closed position by the permanent magnetic field that then prevails when the coil is deactivated. By activating the coil, a coil magnetic field that weakens or neutralizes the permanent magnetic field can be generated, so that the gripper fingers move into the open position due to an inherent restoring force of the leaf spring clips and remain positioned there until the coil is deactivated again. This can be referred to as a “normally closed” gripping function.

A “normally open” handle function with monostable functionality can also be provided with a reversed design of the actuating device.

In one possible embodiment of the gripping tool, the gripper finger carrier is formed by the base body described above or at least one component thereof. However, a design in which the gripper finger carrier belongs to a separate gripper unit with respect to the base body, which can be mounted or is mounted on the base body while assuming a position of use, is expedient.

A separate gripper finger carrier in relation to the base body is in particular sleeve-shaped and is part of the separate gripper unit, which also contains the leaf spring clips and the gripper fingers. The gripper unit is placed on the base body with the sleeve-shaped gripper finger carrier in the axial direction of the center axis when it assumes the position of use and, in particular, is plugged on, whereby the gripper finger carrier is conveniently fixed to the base body in a preferably detachable manner by a securing device. A detachable securing device enables the gripper unit to be replaced as required in order to adapt the gripper unit to different gripping tasks.

The securing device is conveniently designed as a bayonet connection device. For assembly, the gripper unit can be attached to the base body and secured by twisting.

An identification ring can be placed coaxially on the gripper finger carrier, by means of which the installed gripper fingers and/or leaf spring clips can be identified with regard to their design. Gripper units equipped with different gripper fingers and/or leaf spring clips can be provided, which can be distinguished from each other by differently designed identification rings so that they can be easily identified and selected for mounting on a base body. In particular, a color scheme can be used as an identification feature by providing different types of gripper units with identification rings of different colors.

The identification ring can also take over the function of the fixing ring mentioned above, which is involved in fixing the leaf spring clips.

It is advantageous if the drive element can be moved during its drive movement in the axial direction of the center axis between a front-end position that can be fixed by spring forces of the leaf spring clips and a rear end position that is opposite to this. While the rear end position can be preset, for example, by the drive element resting against a component of the optional base body, a stop element arranged on the gripper finger carrier, which projects into the stroke path of the drive element, is expedient for presetting the front-end position. The stop element can effectively prevent the resiliently suspended gripper fingers from swinging during the opening process. It is expedient for the stop element to have damping properties, for example by being at least partially made of a flexible and in particular elastic plastic material.

According to a preferred embodiment, a guide element for the gripper fingers projecting in the axial direction of the center axis can be arranged on the gripper finger carrier in the region of a front side facing the gripper fingers. The gripper fingers are supported by the guide element in a direction that is orthogonal to a swivel plane along which the gripper fingers can move during the inward swivel movement and the outward swivel movement. This measure ensures that the gripper fingers are reliably supported laterally and prevented from uncontrolled relative movements with respect to the gripper finger carrier, even when gripping heavy loads and/or moving at high speed.

In particular, the gripper fingers are guided in such a way that each gripper finger has a guide recess open on the inside associated with the center axis, into which the guide element with a guide extension plunges. In particular, the guide element has a basis section that is fixed to the gripper finger carrier and on which all guide extensions are arranged to protrude radially like wings. If a stop element is present, it is advantageous if the guide element is attached to this stop element and these two elements together form a guide and stop unit that is attached to the gripper finger carrier.

### BRIEF DESCRIPTION OF THE DRAWINGS

The invention is explained in more detail below with reference to the enclosed drawing. It shows:

FIG. 1 a gripper unit of a preferred embodiment of the gripping tool according to the invention in a perspective rear view, whereby a base body of the gripping tool is only schematically indicated by a dotted line,

FIG. 2 Front perspective view of the gripper unit from FIG. 1,

FIG. 3 a longitudinal section of the gripping tool according to sectional planes III-III from FIGS. 1 and 2 with the base body only indicated by a dotted line,

FIG. 4 which corresponds to FIG. 1, shows a further example of the gripping tool according to the invention,

FIG. 5 is a perspective front view of the gripper unit illustrated in FIG. 4,

FIG. 6 the gripper unit from FIG. 5, omitting an optional guide element to better visualize the fixing of the leaf spring clips to the drive element, and

FIG. 7 a longitudinal section of the gripping tool according to sectional planes VII-VII from FIGS. 4 and 5, whereby a base body of the gripping tool is again only schematically indicated by a dotted line.

### DETAILED DESCRIPTION OF THE INVENTION

Unless otherwise specified in individual cases, the following explanations apply to all embodiments of the gripping tool designated in its entirety by reference number 1.

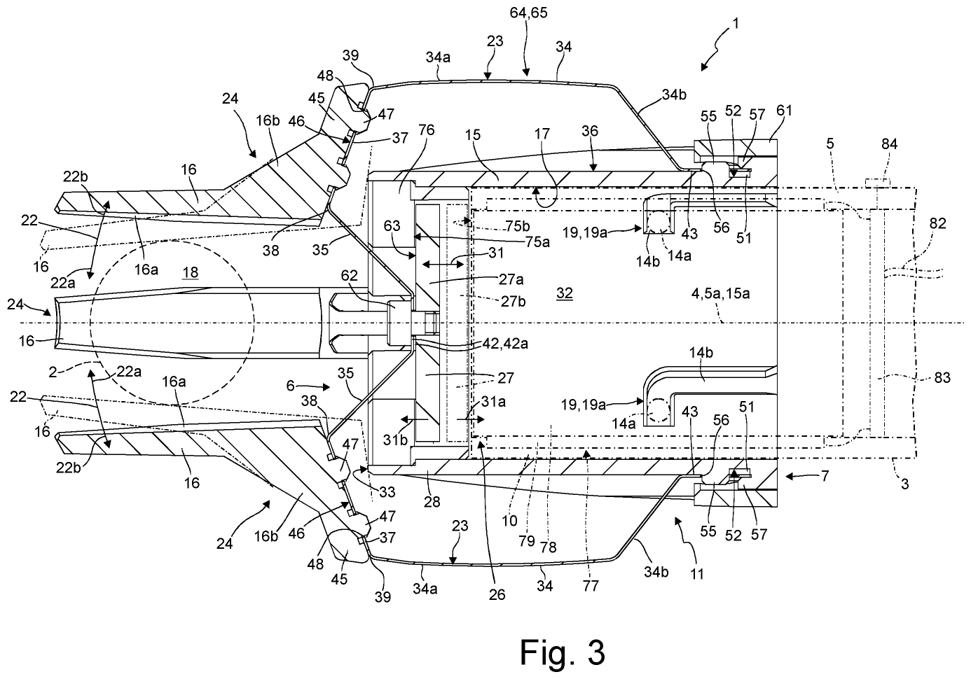

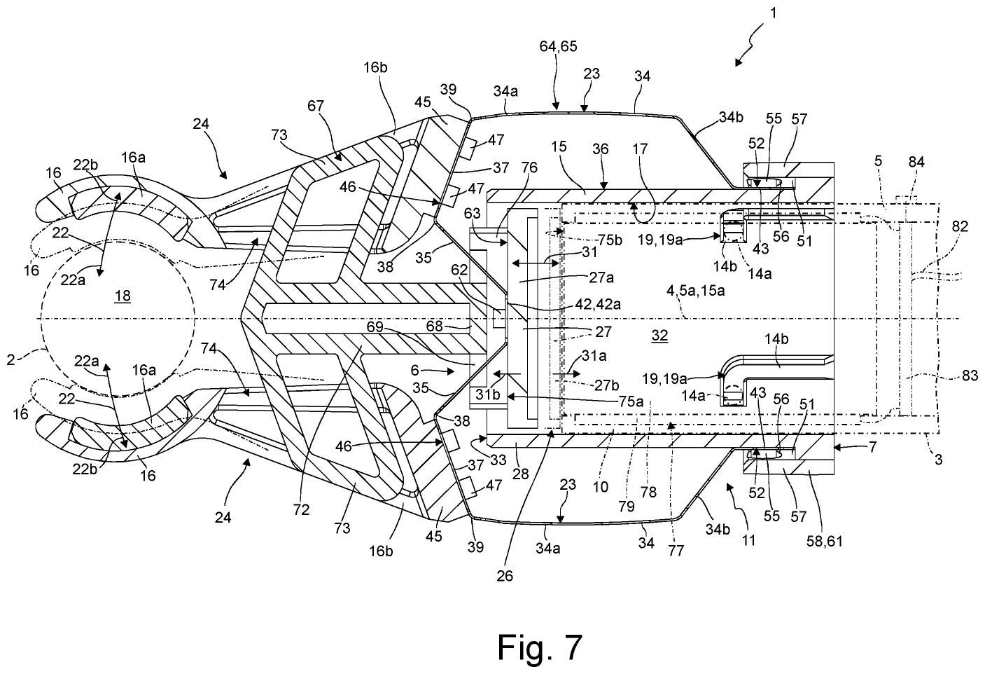

The gripping tool 1 enables the detachable gripping of individual objects 2, one of which is indicated by a dashed line in FIGS. 3 and 7.

The gripping tool 1 has an imaginary central longitudinal axis designated as the center axis 4. It also has a base body 5 with a longitudinal extension, which has a longitudinal axis 5a that coincides with the center axis 4 as an example.

A handling section 3 is located on the base body 5, which can be gripped with one hand in order to move the gripping tool 1 for the purpose of gripping an object 2, moving it to another position and releasing it again. In addition or alternatively, a fastening interface can be provided on the gripping tool 1, with which it can be fixed to the movable arm of a robot or other handling device, not shown further, in order to be moved automatically.

The objects 2 can be technical items such as workpieces, but also food or medical items, for example.

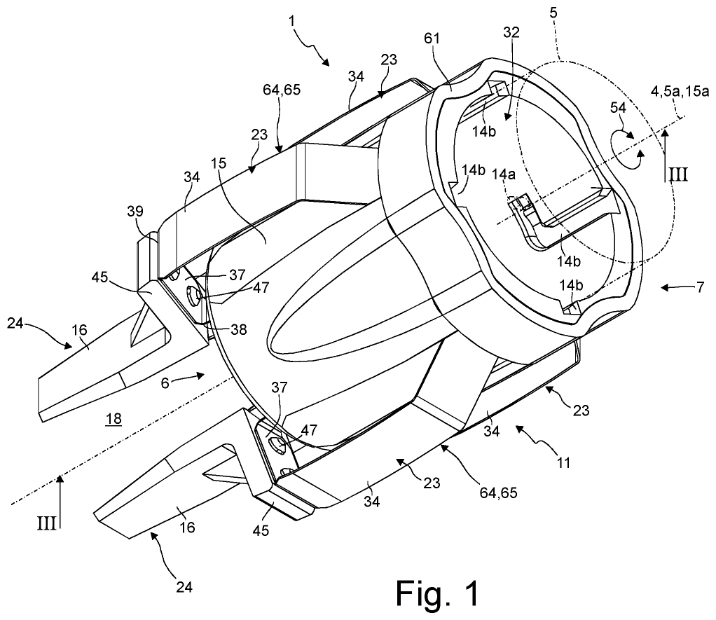

A gripper unit 11 of the gripping tool 1 is arranged on a front-end section 10 of the base body 5. The gripper unit 11 has a separate gripper finger carrier 15 with respect to the base body 5, via which the gripper unit 11 is mounted on the front-end section 10 of the base body 5 in a position of use as shown in FIGS. 1, 3, 4 and 7. As an example, the gripper finger carrier 15 is sleeve-shaped and is placed coaxially on the front-end section 10 of the base body 5 in such a way that its longitudinal axis 5a coincides with the center axis 4. As an example, the gripper finger carrier 15 is fitted coaxially onto the front-end section 10.

The sleeve-shaped gripper finger carrier 15 is preferably made of plastic. During its mounting on the base body 5, it can be very easily placed on the base body 5 with its open rear side 7 facing forwards, so that the drive unit 77 comes to rest at least partially inside the gripper finger carrier 15.

The base body 5 has a circular cylindrical shape, at least at its front-end section 10 which dips into the gripper finger carrier 15.

It has several radially protruding securing pins 14a on its outer circumference distributed around the longitudinal axis 5a, which engage in securing grooves 14b formed in the radial inner circumferential surface 17 of the gripper finger carrier 15.

Together, the securing pins 14a and securing grooves 14b form a securing device 19, with the aid of which the gripper finger carrier 15, which is plugged onto the base body 5, is detachably fixed to the base body 5. The securing device 19 is exemplarily designed as a bayonet connection device 19a, which makes it possible to fix the gripper finger carrier 15 and thus the entire gripper unit 11 on the base body 5 in a combined plug-rotation process. By reversing the movement sequence, the gripper unit 11 can also be removed from the base body 5 again if required.

In a non-illustrated exemplary embodiment, the gripper finger carrier 15 is designed as an integral component of the base body 5 and, in particular, is formed directly by the front-end section 10 of the base body 5.

The gripper finger carrier 15 has a front side 6 oriented in the axial direction of the center axis 4 and a rear side 7 axially opposite to it.

The gripper finger carrier 15 carries several gripper fingers 16 arranged in the region of the front side 6, which are distributed around the center axis 4. Preferably, the gripper fingers 16 are positioned in front of the gripper finger carrier 15 in the axial direction of the center axis 4. Preferably, the gripper fingers 16 are evenly distributed.

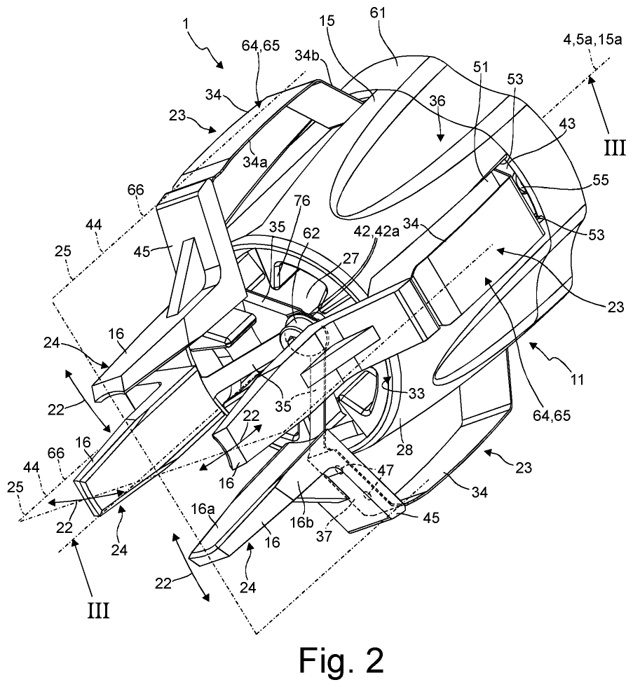

Each gripper finger 16 is arranged as a separate component on at least one one-piece leaf spring clip 23 having spring-elastic properties and is fixed to the gripper finger carrier 15 via this at least one leaf spring clip 23. According to the exemplary embodiment of FIGS. 1 to 3, each gripper finger 16 is attached to a single leaf spring clip 23, with each assembly composed of a gripper finger 16 and a leaf spring clip 23 forming a gripper arm 24. The gripping tool 1 of FIGS. 1 to 3 has a total of four such gripper arms 24, which are arranged at angular distances of 90 degrees around the center axis 4.

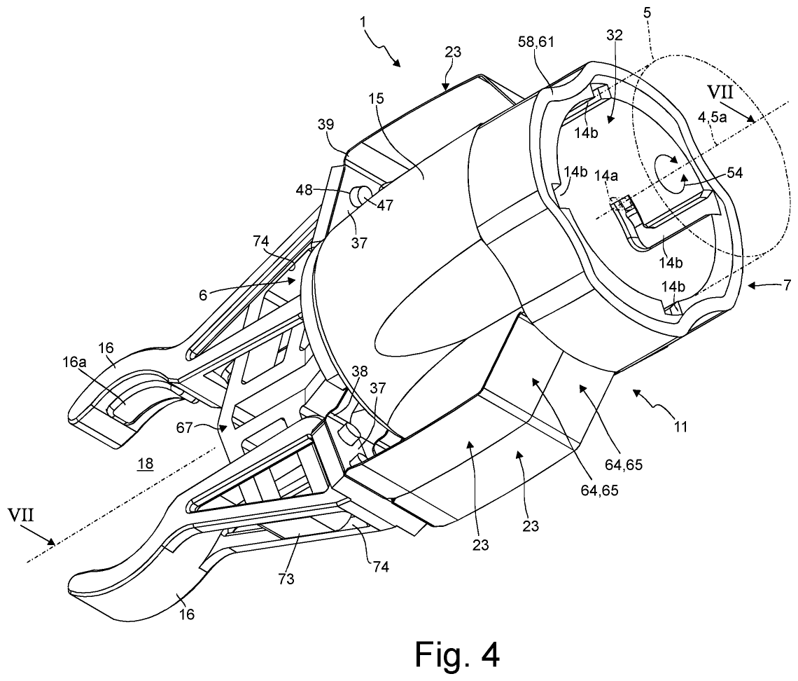

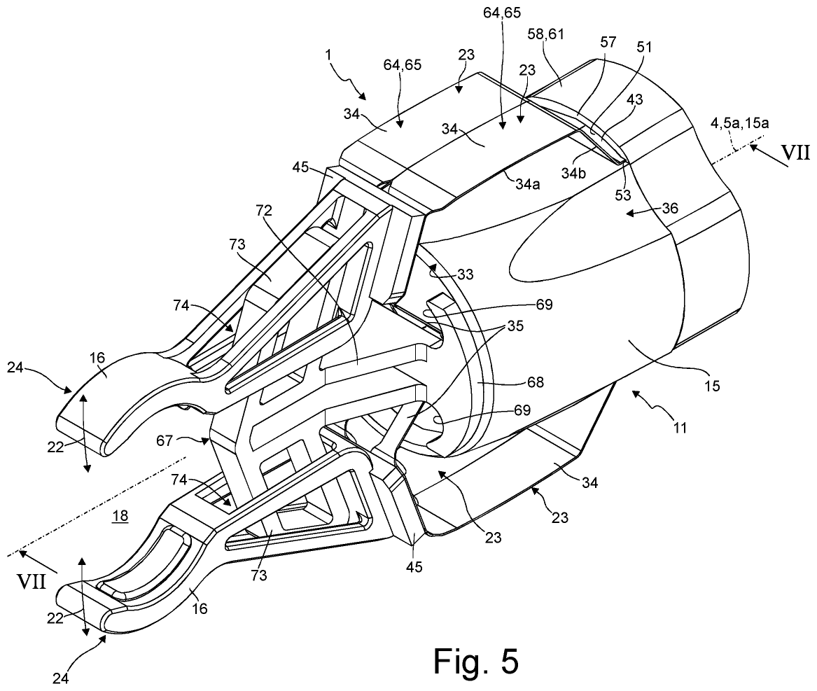

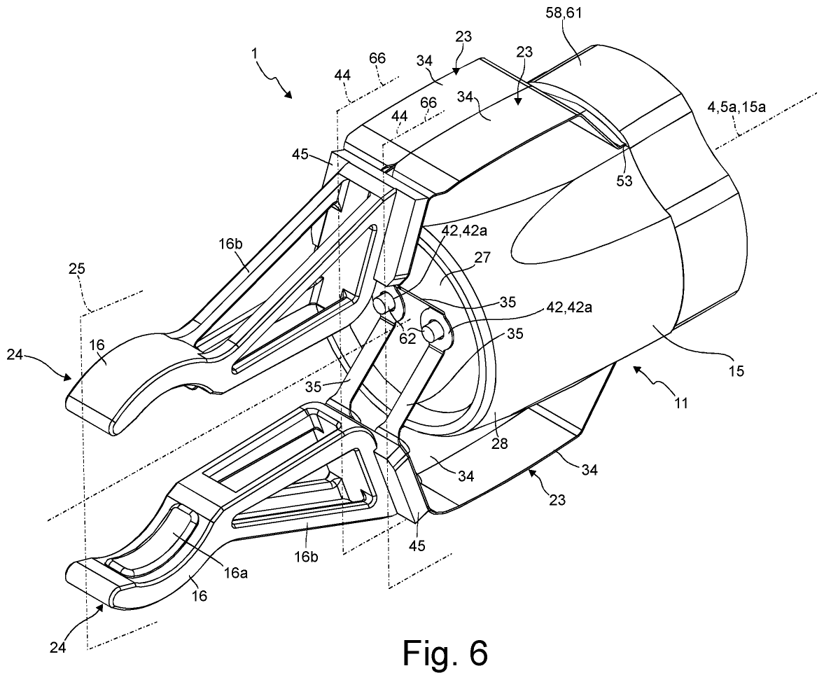

According to the embodiment example of FIGS. 4 to 7, each gripper finger 16 can be attached simultaneously to several and in particular to exactly two leaf spring clips 23. In this way, each gripper arm 24 is composed of a gripper finger 16 and two leaf spring clips 23 placed next to each other, the two leaf spring clips 23 corresponding functionally to a single leaf spring clip 23. The embodiment example of FIGS. 4 to 7 has two gripper arms 24, which are diametrically opposite to each other with respect to the center axis 4.

Due to their spring elasticity, the leaf spring clips 23, preferably consisting of a spring steel, provide the respective associated gripper finger 16 with a mobility for executing a relative swivel movement with respect to the gripper finger carrier 15, referred to as a gripper finger swivel movement 22 and indicated by a double arrow. Each gripper finger swivel movement 22 can alternatively be an inward swivel movement 22a oriented inwards in the direction of the center axis 4 or an outward swivel movement 22b opposite thereto and moving away from the center axis 4.

The gripper finger swivel movement 22 is synchronized for all gripper fingers 16, i.e., it takes place simultaneously and in the same direction.

The outward swivel movement 22b allows the gripper fingers 16 to be displaced into an open position at a maximum distance from the center axis 4, which can be seen in all figures. The inward swivel movement 22a allows the gripper fingers 16 to be moved into a closed position close to the center axis 4, the distance to the center axis 4 depending on whether an object 2 is arranged in a gripping space 18 surrounded by the gripper fingers 16 and, if so, the dimensions of this object 2. Each gripper finger swivel movement 22 conveniently takes place in a gripper finger swivel plane 25, indicated by a dotted line, which is spanned by the center axis 4 and an axis orthogonal or radial thereto.

Each gripper finger 16 has a gripping section 16a, which can be designed depending on the shape of the object 2 to be gripped. In the exemplary embodiment of FIGS. 1 and 3, the gripping sections 16a are integrated integrally into the respective associated gripper finger 16. According to the exemplary embodiment of FIGS. 4 to 7, the gripping sections 16a can also be integrated into the gripper fingers 16 as separate components, for example even interchangeably.

To execute the gripper finger swivel movements 22, the gripping tool 1 is equipped with an actuating device 26 based on a magnetic operating principle.

The actuating device 26 includes a drive element 27, which is preferably associated with a front-end section 28 of the gripper finger carrier 15 facing the front side 6. The drive element 27 can be driven by magnetic forces generated by the actuating device 26 to perform a drive movement 31 indicated by a double arrow, which takes place relative to the gripper finger carrier 15 and which can be oriented in the two axial directions of the center axis 4.

Thus, the drive element 27 can be moved back and forth linearly in the axial direction of the center axis 4 relative to the gripper finger carrier 15. The drive movement 31 can also be described as a stroke movement.

The drive element 27 is conveniently located in a carrier interior 32 enclosed by the gripper finger carrier 15, specifically in the vicinity of an annular front-end face 33 of the gripper finger carrier 15, which closes off the front-end section 28. Preferably, the drive element 27 is always located within the carrier interior 32, irrespective of its stroke position.

The drive element 27 is conveniently plate-shaped or disk-shaped, which applies to the illustrated embodiments. Its main plane of expansion is orthogonal to the center axis 4. Conveniently, the drive element 27 together with the leaf spring clips 23, the gripper fingers 16 and the gripper finger carrier 15 form part of the gripper unit 11, which can be handled in a uniform manner by way of example.

Each leaf spring clip 23 has an outer clip section 34 forming a first suspension arm and an inner clip section 35 forming a second suspension arm. Each leaf spring clip 23 is fastened via its outer clip section 34 to the gripper finger carrier 15 in the region of its outer circumferential surface 36 radially facing away from the center axis 4. Furthermore, each leaf spring clip 23 is attached to the drive element 27 via its inner clip section 35. A longitudinal section designated as finger attachment section 37 connects the outer clip section 34 with the inner clip section 35 of each leaf spring clip 23, whereby the associated gripper finger 16 is attached to this finger attachment section 37.

During the drive movement 31, the inner clip sections 35 are entrained by the drive element 27, resulting in a general spring-elastic deformation of the leaf spring clips 23, which in turn entrains the gripper fingers 16 fixed to the finger attachment sections 37. This is expressed in the gripper finger swivel movement 22, more precisely in an outward swivel movement 22b when the drive element 27 is displaced in the direction of the front side 6 and in an inward swivel movement 22a when the drive element 27 is displaced in the direction of the rear side 7.

As an example, the leaf spring clips 23 are shaped in such a way that when the drive element 27 is not subjected to a drive force or to a magnetic force, they move to a basic position as shown in the drawing, in which the gripper fingers 16 are in the open position. To cause the inward swivel movement 22a, a drive force must be exerted on the drive element 27, which displaces the drive element 27 in the direction of the rear side 7. In doing so, a spring return force of the leaf spring clip 23 must be overcome which, when the drive force acting on the drive element 27 is removed, tends to cause the gripper fingers 16 to swivel back into the open position.

Conveniently, the finger attachment section 37 of each leaf spring clip 23 has an inclined orientation with respect to the center axis 4. In an inner clip transition region 38, the finger attachment section 37 transitions at an angle into the inner clip section 35, which also has an inclined orientation with respect to the center axis 4 and extends obliquely in the direction of the rear side 7 and simultaneously in the direction of the center axis 4, terminating in an inner attachment end section 42, by means of which it is attached to the drive element 27. The inner attachment end section 42 is in particular an angled end section of the inner clip section 35.

The inner transition region 38 is located axially in front of the gripper finger carrier 15 in the region of the front side 6, whereby it is closer to the center axis 4 than an outer transition region 39 located radially further out, in which the finger attachment section 37 merges into the outer transition section 34 at an angle.

The outer transition region 39 is closer to the rear side 7 than the inner transition region 38 and is also further away from the center axis 4 than the inner transition region 38 and, in particular, the radial outer circumferential surface 36 of the gripper finger carrier 15. Starting from the outer clip transition region 39, the outer clip section 34 extends at a radial distance from the gripper finger carrier 15 in the direction of the rear side 7, ending with an outer attachment end section 43, via which it is fastened to the gripper finger carrier 15.

The outer clip section 34 has a bent longitudinal course, whereby a first longitudinal section 34a, which is slightly or not inclined with respect to the center axis 4 and starts from the outer clip transition region 39, is followed by a more inclined second longitudinal section 34b, which extends obliquely towards the rear side 7 and at the same time inwards in the direction of the center axis 4, the end section of which is again angled to form the outer attachment end section 43.

Each leaf spring clip 23 consists of a strip-shaped flat material which has a smaller width than the shackle length and a smaller thickness than the width.

Each leaf spring clip 23 extends with its non-linear longitudinal axis in a spring plane 44, which coincides with the gripper finger swivel plane 25. The width of the leaf spring clip 23 is orthogonal to the spring plane 44.

The gripper fingers 16 are attached to the finger attachment sections 37. As an example, the gripper fingers 16 are attached with a finger socket 45 to a mounting surface 46 of the finger attachment section 37 facing away from the gripper finger carrier 15. Since the gripper fingers 16 are designed as separate components with respect to the leaf spring clips 23, they can be manufactured at low cost in the desired design before being joined to the leaf spring clips 23. They are preferably made of plastic, but can also be made of other materials.

The gripper fingers 16 can be detachably attached to the leaf spring clips 23, which applies to the exemplary embodiment of FIGS. 1 to 3. Here, each finger socket 45 has one or more fastening pins 47, which are provided with a latching contour and are inserted into fastening holes 48 of the finger attachment section 37 with releasable latching and are thus clipped in. Alternatively, a detachable screw connection could also be considered, for example.

Alternatively, a non-detachable connection comparable to the embodiment example of FIGS. 4 to 7 is possible, in which fastening pins 47 are again inserted through fastening holes 48 and caulked at their free ends under the effect of heat. It is also possible to form gripper fingers made of plastic directly onto the previously provided leaf spring clips 23 during their initial shaping, for example by injection molding.

It has proven to be advantageous if the leaf spring clips 23 have a constant thickness over their entire length. They can then be manufactured very easily from a steel plate, for example using a stamping and bending process.

In principle, the leaf spring clips 23 can have a constant width over their length. However, an embodiment is preferred in which, in accordance with the illustrated exemplary embodiments, the finger attachment section 37 is narrower than the adjoining length section of the outer clip section 34 and is also wider than the adjoining length section of the inner clip section 35. Conveniently, the outer clip section 34 has a constant width at least up to the start of the outer attachment end section 43, just as the inner clip section 35 also has a constant width at least up to the start of the inner attachment end section 42.

In the illustrated embodiments, each leaf spring clip 23 is attached to the gripper finger carrier 15 and to the drive element 27 in a particularly advantageous manner.

For fastening the outer clip sections 34, a groove-like retaining recess 51 is formed in the outer circumferential surface 36 of the gripper finger carrier 15 for each leaf spring clip 23, which extends in the axial direction of the center axis 4. The retaining recess 51 has a base surface 52 facing away from the center axis 4 and two lateral boundary surfaces 53 which are opposite each other at a distance in the circumferential direction 54 of the gripper finger carrier 15. The circumferential direction 54 is indicated by a double arrow and is understood to be the direction around the center axis 4.

At least one fastening pin 55 rises from the base surface 52, the outer diameter of which corresponds at least substantially to the inner diameter of a fastening hole 56 passing through the inner attachment end portion 42. The distance between the two boundary surfaces 53 corresponds to the width of the outer attachment end section 43.

The outer clip section 34 is inserted with the outer attachment end section 43 into the retaining recess 51 in such a way that its fastening hole 56 is penetrated by the fastening pin 55 and the two lateral edge surfaces of the outer attachment end section 43 are supported by the lateral boundary surfaces 53. In this way, the outer clip section 34 is prevented from translational movements with respect to the gripper finger carrier 15 by positive fitting by the fastening pin 55 and, in addition, is unalterably aligned by the contact with the lateral boundary surfaces 53 in such a way that the spring plane 44 maintains its relative position with respect to the center axis 4 at a constant level.

Accidental detaching the outer attachment end section 43 from the fastening pin 55 is prevented by the fact that a fixing bar 57 is arranged on the gripper finger carrier 15 in the region of each retaining recess 51, which bridges the retaining recess 51 at a height distance from the base surface 52 and which is engaged under by the end region of the outer attachment end section 43 inserted into the retaining recess 51. With this type of fastening, the leaf spring clip 23 can only be fitted or removed as long as the leaf spring clip 23 is not fastened to the drive element 27 and is inserted into or removed from the retaining recess 51 as part of a swivel movement.

In the embodiment example of FIGS. 1 to 3, the fixing bar 57 is an integral component of the gripper finger carrier 15 and is formed in one piece with the adjacent components of the gripper finger carrier 15. It conveniently extends beyond the end region of the associated retaining recess 51 that is axially opposite the gripper fingers 16.

In contrast, according to the exemplary embodiment of FIGS. 4 to 7, the fixing bar 57 can be formed by a section of a fixing ring 58, which is placed on the gripper finger carrier 15 in the region of the retaining recesses 51 coaxially to the center axis 4 and encloses the gripper finger carrier 15 in the region of the retaining recesses 51. In this case, those sections of the fixing ring 58 that each bridge one of the retaining recesses 51 function as a fixing bar 57 for holding an outer attachment end section 43 of one of the leaf spring clips 23. The fixing ring 58 can be fixed to the gripper finger carrier 15, for example, as part of a snap-in connection, screw connection or press connection.

The distance between the fixing bar 57 and the base surface 52 of the retaining recess 51 is conveniently somewhat greater than the thickness of the outer attachment end section 43 engaging under the fixing bar 57, so that the outer attachment end section 43 sits on the associated fastening pin 55 with limited movement in a radial direction with respect to the center axis 4. This favors the elastic deformability of the leaf spring clip 23.

Preferably, the fixing ring 58 has a dual function and also acts as an identification ring 61, which can be used to identify the gripper arm equipment of the gripper unit 11 at a glance. For example, a certain color of the identification ring 61 can indicate a certain shape of the assigned gripper fingers 16. Alphanumeric labeling to identify the gripper unit 11 is also possible.

An identification ring 61 can also be used without an additional fixing function in accordance with the exemplary embodiment of FIGS. 1 and 3. It is also possible to use a combination of integral fixing bars 57 and fixing bars 57 formed on a fixing ring 58 to fix the outer attachment end sections 43.

In order to fix the leaf spring clips 23 to the drive element 27, the inner attachment end sections 42 are preferably designed as fastening eyes 42a, through which a fastening element 62 passes. As an example, the fastening eyes 42a are supported on the front-end face 63 of the drive element 27 facing the gripper fingers 16, with which they are braced in each case by a fastening element 62 in the form of a screw, which passes through the fastening eye 42a and is screwed to the drive element 27.

The type of fastening of the inner attachment end section 42 can be detachable or non-detachable. A screw connection according to the embodiment examples can be easily loosened again at any time. Other preferred types of connection include, for example, a connection by latching, riveting or caulking.

In an advantageous manner, the front-end face 33 of the gripper finger carrier 15 can function as a support surface on which the gripper fingers 16 can be axially supported directly or via the associated finger attachment section 37 during the inward swivel movement 22a, as shown in the dotted line illustration in FIG. 3. In this way, additional safety is provided to the effect that the gripper finger carrier 15 is pulled away from the base body 5 due to the prevailing spring forces. This results in a kind of self-locking mechanism that prevents the gripper finger carrier 15 from being pulled off forcibly and thus from being damaged.

The leaf spring clips 23 can each be individually designed and individually integrated into the gripper unit 11. However, easier assembly can be achieved if at least several of the leaf spring clips 23 are firmly connected to one another at their inner clip sections 35, in particular in the region of the inner attachment end sections 42, and thus form a spring clip unit 64 composed of several leaf spring clips 23. The leaf spring clips 23 combined in the spring clip unit 64 can, for example, be welded together or are preferably formed as integral sections of a one-piece body. In other words, the spring clip unit 64 is formed in one piece in this case.

A one-piece spring clip unit 64 can be realized with both an even and an odd number of leaf spring clips 23.

It is considered particularly advantageous to use one or more spring clip units 64 to implement the gripping tool 1, each of which is composed of a pair of spring clips 65 consisting of two leaf spring clips 23 located orthogonally to the center axis and lying in a common spring clip pair plane 66. Each spring clip pair plane 66 results from the coinciding spring planes 44 of the two combined leaf spring clips 23. Such a configuration is present in both illustrated embodiments.

In the exemplary embodiment of FIGS. 1 to 3, a total of two pairs of spring clips 65 are formed from four leaf spring clips 23 lying opposite each other in pairs, each of which forms a spring clip unit 64. The two pairs of spring clips 65 or spring clip units 64 are arranged in a crossover configuration with mutually perpendicular spring clip pair planes 66, each of the four leaf spring clips 23 being attached to the gripper finger carrier 15 via its outer clip section 34 and to the drive element 25 via its inner clip section 35. Each leaf spring clip 23 carries one of two opposing pairs of gripper fingers 16, resulting in a four-finger gripper.

The gripping tool 1 of FIGS. 4 to 7 also contains four leaf spring clips 23, which are combined to form two pairs of spring clips 65, each of which is designed as a spring clip unit 64. In this case, however, the two pairs of spring clips 65 are arranged adjacent to each other in a side-by-side configuration in such a way that their spring clip pair planes 66 run parallel to each other. In this case, the attachment regions for the four leaf spring clips 23 located on the outer circumference of the gripper finger carrier 15 are distributed in such a way that two attachment regions are located directly next to each other in the circumferential direction 54. The two pairs of attachment regions are located on diametrically opposed sections of the outer circumferential surface 36.

Despite the immediate proximity of two attachment regions, each outer attachment end section 43 can be held in its own retaining recess 51. Alternatively, the two outer attachment end sections 43 arranged next to each other can be fixed together in a single, correspondingly wider retaining recess 51. In this case, the two attachment end sections 43 are supported against each other with their lateral edge surfaces facing each other and are also supported against one of the two lateral boundary surfaces 53 with their lateral edge surfaces facing away from each other.

Conveniently, the two pairs of spring clips 64 arranged next to each other rest at least and preferably exclusively with their outer clip sections 34 against each other lengthwise. The gripping tool 1 of FIGS. 4 to 7 has only two gripper fingers 16, each of these two gripper fingers 16 being attached to the adjacent finger attachment sections 37 of both pairs of spring clips 65. The double arrangement of the spring clip pairs 65 achieves particularly high spring forces and high stability during the gripper finger swivel movements 22.

In each pair of spring clips 65, the leaf spring clips 23 conveniently have a common inner attachment end portion 42. As an example, each spring clip unit 64 has a fastening eyelet 42a which forms an inner attachment end portion 62 of both associated leaf spring clips 23.

The exemplary embodiment in FIGS. 4 to 7 represents a two-finger gripper. It is understood that a two-finger gripper can also be realized with only a single pair of spring clips 65.

The two spring clip units 64 arranged crosswise according to FIGS. 1 to 3 are preferably fastened together on the drive element 27. As an example, their two fastening eyes 42a lie on top of one another so that their openings are aligned with one another, with a fastening element 62 anchored to the drive element 27 passing through them together.

The two spring clip units 64 arranged next to each other with identical orientation according to FIGS. 4 to 7 are preferably each fastened to the drive element 27 by a separate fastening element 62 passing through the associated fastening eye 42a.

The leaf spring clips 23 of a respective gripping tool 1 are preferably identical to each other. The same applies to the spring clip units 64 of the respective gripping tool 1.

In principle, the gripping tool 1 can be designed as an external gripper gripping an object 2 on the outside, as shown, or as an internal gripper that plunges into an object to be gripped and grips from the inside.

The gripper fingers 16 can absorb particularly high transverse forces if they are supported orthogonally to the gripper finger swivel plane 25 with respect to the gripper finger carrier 15. This is the case in the embodiment example in FIGS. 4 to 7. At least one guide element 67 is responsible for the support, whereby a single guide element 67 is conveniently responsible for the support of all gripper fingers 16. This is the case in the embodiment example of FIGS. 4 to 7, where a single guide element 67 is used for the simultaneous transverse support of both gripper fingers 16 and their precise guidance during the gripper finger swivel movement 22.

The guide element 67 is firmly attached to the gripper finger carrier 15 in the region of the front side 6. As an example, it is attached via a basis section 68 of the guide element 67, which is inserted into the front-end section 28 of the gripper finger carrier 15 and is supported on the inner circumferential surface 17 of the gripper finger carrier 15. The basis section 68 is pressed, glued or welded into the gripper finger carrier 15, for example.

As an example, the basis section 68 has a disk-shaped basic structure and has, in diametrically opposed regions, one of two edge-side basis recesses 69, through which the inner clip sections 35 extend in a freely movable manner. The drive element 27 adjoins the basis section 68 towards the rear side 7.

A retaining section 72, which extends between the gripper fingers 16, projects from the basis section 68 centrally in the axial direction of the center axis 4 towards the gripper fingers 16. Two guide projections 73 are formed on the retaining section 72, which project in the gripper finger swivel plane 25 like wings in opposite directions transversely to the center axis 4 and each enter a guide recess 74 of one of the gripper fingers 16 that is open towards the center axis 4. As an example, the guide recesses 74 are formed as slot-like openings in the gripper fingers 16. Each guide recess 74 has two inner surfaces lying opposite to each other orthogonally to the gripper finger swivel plane 25, which bear in a slidingly displaceable manner against the guide projection 73 which enters the guide recess 74, so that the gripper finger 16 can slide along the associated guide projection 73 during the gripper finger swivel movement 25.

The guide recesses 74 are preferably formed in a base section 16b of the respective gripper finger 16, which extends between the finger socket 45 and the gripping section 16a. The guide element 67 ends before reaching the gripping section 16a, so that the gripping function is guaranteed without restriction.

During the drive movement 31, the drive element 27 can move linearly between a front-end position 27a, shown in solid lines in FIGS. 3 and 7, and a rear end position 27b, indicated by a dotted line and spaced apart in the axial direction of the center axis 4. Both end positions 27a, 27b are conveniently defined by front stop surfaces 75a and rear stop surfaces 75b which are stationary relative to the gripper finger carrier 15. The front stop surface 75a is located on a stop element 76 fixed to the gripper finger carrier 15 in the region of the front-end section 28, while the rear stop surface 75b is preferably formed on the base body 5 or on a component of the actuating device 26 fixed to the base body 5.

When opening and closing the gripper arms 24, the stop element 76 conveniently moves between the two end positions 27a, 27b. The inward swivel movement 22a of the gripper fingers 16 can be caused by a backward movement 31a of the drive element 27 pointing towards the rear side 7, the outward swivel movement 22b by a forward movement 31b of the drive movement 31 in the direction of the front side 6. When the drive element 27 moves towards its rear end position 27b to grip an object 2, i.e., performs the backward movement 31a, the object 2 is conveniently already gripped before the drive element 27 reaches the rear stop surface 75b. The elasticity of the leaf spring clips 23 nevertheless allows the drive element 27 to continue moving until it comes into contact with the rear stop surface 75b, whereby the spring-elastic deformation of the leaf spring clips 23 builds up a clamping force that securely holds the object 2. Preferably, the gripper arms 16 are always in contact with the front-end face 33 of the gripper finger carrier 15 in the rear end position 27b of the drive element 27, as already explained above.

The stop element 76 always ensures a defined open position of the gripper fingers 16, which are attached to the drive element 27 via the inner clip section 35. The contact of the drive element 27 with the stop element 76 also prevents undesired oscillations of the gripper fingers 16, which are elastically suspended via the leaf spring clips 23. This vibration-preventing effect can be further enhanced by the use of a stop element 76 with at least partial vibration-damping properties. For example, the stop element 76 can consist of a flexible plastic material, for example an elastomer body or a foamed plastic material, at least in the regions defining the front stop surface 75a.

If a guide element 67 is present in accordance with the exemplary embodiment of FIGS. 4 to 7, the stop element 76 can be formed in an assembly with the guide element 67 in accordance with the illustrated exemplary embodiment. For example, the stop element 76 can be fixedly attached to the basis section 68 or can be formed by an integral component of the basis section 68. In this case, the guide element 67 and the stop element 76 represent a combined guide and stop unit.

In addition to the drive element 27, the actuating device 26, which operates according to a magnetic functional principle, has a drive unit 77 which is designed to generate its drive movement 31 and which, by way of example, is at least partially and preferably completely accommodated in the base body 5. It is capable of cooperating magnetically with the drive element 27 and, for this purpose, selectively exerting magnetic drive forces on the drive element 27, from which the drive movement 31 results. As an example, the selectivity manifests itself in the imposition of drive forces of varying strength up to a complete removal of the magnetic drive forces.

The drive element 27 has magnetizable properties and preferably consists at least partially of a ferromagnetic material for this purpose. As an example, the drive element 27 as a whole is a ferromagnetic element.

To obtain the magnetizable properties, the drive element 27 can be a body made of magnetizable material or be designed as a multi-component element consisting, for example, of a plastic part and a ferromagnetic steel plate embedded in it.

At least one magnetic field can be provided by the drive unit 77, which can interact with the ferromagnetic drive element 27 in order to exert magnetic drive forces on the drive element 27, which can cause the drive movement 31 in at least one direction. Preferably, the drive unit 77 includes a permanent magnet 78 that constantly provides a permanent magnetic field. The permanent magnet 78 is conveniently magnetized in the axial direction of the center axis 4. It can be made of one or more parts and is cylindrically shaped as an example. Conveniently, the rear stop surface 75b mentioned above is formed by a front-end face of the permanent magnet 78 facing the drive element 27.

The drive unit 77 also contains an electrically energizable coil 79, by energizing it, a coil magnetic field superimposed on the permanent magnetic field of the permanent magnet 78 can be generated. The coil 79 is preferably arranged coaxially around the permanent magnet 78. The overall magnetic field acting on the drive element 27 is the result of the interaction between the permanent magnetic field and the coil magnetic field.

An electromechanical interface 82 is located on the base body 5, which is connected to an internal control electronics 83 of the drive unit 77 and via which an electrical operating voltage can be applied externally. The electromechanical interface 82 is preferably a plug-in interface, but can also be realized, for example, by an outgoing electrical cable. The coil winding of the coil 79 is connected to the control electronics 83, conveniently with the inclusion of a switch-over device 84, which can be operated manually in particular and is arranged on the base body 5 in a manner accessible from the outside.

The switch-over device 84, which includes for example a switch-over button, allows selective specification of a current flow direction of the coil 79. In this way, the coil 79 can alternatively be energized or activated with one of two opposing current directions, resulting in two oppositely polarized coil magnetic fields, one of which is opposite to the permanent magnetic field and the other of which is in the same direction as the permanent magnetic field. In other words, a coil magnetic field that either weakens or strengthens the permanent magnetic field can be generated, depending on which direction of current flow in the activated coil is specified by the switching device 84. The weakening can go as far as a neutralization of the permanent magnetic field.

The switching device 84 also allows the coil 79 to be deactivated in order to prevent the generation of a coil magnetic field.

The actuating device 26 is designed in such a way that the permanent magnetic field alone is not able to move the drive element 27, which is held in the front-end position 27a by the restoring force of the leaf spring clip 23, in the direction of the rear end position 27b. In this respect, the open position of the gripper fingers with deactivated coil 79 is a stable gripper finger position.

In order to cause the inward swivel movement 22a starting from the open position, the coil 79 can be activated via the switch-over device 84 in such a way that the permanent magnetic field and the coil magnetic field add up, so that a resulting magnetic field of high strength acts on the drive element 27, which is consequently displaced into the rear end position 27b while performing a backward movement 31b, whereby the gripper fingers 16 reach their closed position.

If the coil 79 is deactivated in the closed position of the gripper fingers, the permanent magnetic field then acting alone is sufficient to hold the drive element 27, which is close to the permanent magnet 78, in the rear end position 27b. Like the open position of the gripper fingers 16, the closed position of the gripper fingers 16 is therefore also a stable gripper finger position fixed without current.

In order to swivel the gripper fingers 16 from the closed position to the open position, the coil 79 can be energized by corresponding actuation of the switch-over device 84 in such a way that the coil magnetic field counteracts the permanent magnetic field and weakens or neutralizes the latter. Since no or only a very low magnetic force now acts on the drive element 27, the drive element 27 can be pulled back into the front end position 27a by the leaf spring clips 23 acting on it due to their resilient restoring force, which is accompanied by the outward swivel movements 22b, in the course of which the gripper fingers 16 are moved back into the open position.

To switch the gripper fingers 16 between the open position and the closed position, regardless of the direction, it is sufficient to briefly activate the coil 79 for a period of only 0.2 seconds, for example. The energy required for this is very low, so that the gripping tool 1 is also suitable for battery operation. For example, a rechargeable battery providing the operating voltage can be mounted in or on the base body 5, which can be removed for recharging or can be recharged via the electromechanical interface 82.

In deviation from the bistable design described above, the actuating device 26 can alternatively also be designed in such a way that it is a stable position only in the open position or only in the closed position, meaning that the gripping tool 1 has a monostable functionality.

In a non-illustrated embodiment example, the drive unit 77 includes a movable permanent magnet arrangement which, depending on its position, is capable of exerting variable magnetic forces on the drive element 27 without the need for energization.

In an embodiment, which is also not illustrated, the drive element 27 has permanent magnetic properties so that it can be actively attracted or repelled by cooperating with at least one magnetic field that can be provided by a drive unit 27 in order to generate the gripper finger swivel movements 22.

The design of the gripping tool 1 makes it possible to realize small dimensions so that the gripping tool 1 can be held with the fingers of one hand, for example, in order to be used for gripping test tubes or vials in medical or pharmaceutical applications. The maximum stroke of the drive element 27 can be in the range of 2.5 mm, for example, in combination with a radial swivel stroke of the gripper fingers 16 in the range of 2 mm each.

1. A gripping tool, with a gripper finger carrier extending along a center axis and a plurality of gripper fingers arranged on the gripper finger carrier distributed around the center axis, wherein the gripper fingers can be driven synchronously by an actuating device based on a magnetic operating principle either to an inward swivel movement oriented inwards in the direction of the center axis or to an outward swivel movement oriented outwards away from the center axis, wherein each gripper finger is attached to the gripper finger carrier via a movable first suspension arm and to a drive element of the actuating device via a movable second suspension arm, wherein the drive element can be driven by the action of magnetic forces relative to the gripper finger carrier to perform a reciprocating drive movement in the axial direction of the center axis, from which either the inward swivel movement or the outward swivel movement of the gripper fingers results, depending on the direction of movement of the drive element,
wherein each gripper finger is arranged as a separate component on at least one one-piece leaf spring clip which has resilient properties and which has an outer clip section forming the first suspension arm and an inner clip section forming the second suspension arm, it being possible for the outer and inner clip sections to bend resiliently during the drive movement of the drive element while entraining the gripper fingers.

2. The gripping tool according to claim 1, wherein each leaf spring clip consists of a spring steel, or
wherein each leaf spring clip has a finger attachment section which connects the outer clip section to the inner clip section and to which the associated gripper finger is attached.

3. The gripping tool according to claim 2, wherein the gripper finger carrier has a front-end face on which the gripper fingers or the finger attachment sections of the leaf spring clips can be axially supported during the inward swivel movement of the gripper fingers.

4. The gripping tool according to claim 2, wherein the finger attachment section is narrower than at least the adjoining length section of the outer clip section and is wider than at least the adjoining length section of the inner clip section, or wherein the finger attachment section of each leaf spring clip has an inclined orientation with respect to the center axis and merges into the inner clip section at an angle in an inner clip transition region and into the outer clip section at an angle in an outer clip transition region, wherein the inner clip transition region is positioned in front of a front side of the gripper finger carrier oriented in the axial direction of the center axis and is located closer to the center axis than the outer clip transition region, which is located closer to a rear side of the gripper finger carrier opposite to the front side than the inner clip transition region, wherein the outer clip section extends from the outer clip transition region at a radial distance from the gripper finger carrier with respect to the center axis in the direction of the rear side of the gripper finger carrier and wherein the inner clip section extends from the inner clip transition region obliquely in the direction of the rear side of the gripper finger carrier and at the same time inwards in the direction of the center axis.

5. The gripping tool according to claim 1, wherein the gripper fingers are detachably or non-detachably attached to the respectively associated leaf spring clip, detachably by latching or non-detachably by caulking.

6. The gripping tool according to claim 1, wherein the outer clip section of each leaf spring clip has an outer attachment end section opposite the associated gripper finger, with which it is attached to the gripper finger carrier.

7. The gripping tool according to claim 6, wherein the outer fastening end section of each leaf spring clip dips into a groove-like retaining recess of the gripper finger carrier, a fastening pin of the gripper finger carrier projecting from a base surface of the retaining recess projecting into a fastening hole of the outer fastening end section, the outer fastening end section is supported at the edge by lateral boundary surfaces of the retaining recess and the outer fastening end section engages under a fixing bar bridging the retaining recess.

8. The gripping tool according to claim 7, wherein the fixing bar is an integral part of the gripper finger carrier or is formed by a section of a separate fixing ring arranged on the gripper finger carrier coaxially to the center axis.

9. The gripping tool according to claim 1, wherein the inner clip section of each leaf spring clip has an inner fastening end section opposite the associated gripper finger, with which it is fastened to the drive element, and/or wherein the inner fastening end section of each leaf spring clip is designed as a fastening eye, through which a fastening element passes for fastening to the drive element.

10. The gripping tool according to claim 1, wherein each leaf spring clip has a constant thickness over its entire length.

11. The gripping tool according to claim 1, wherein the inner clip section of each leaf spring clip has a smaller width than the outer clip section at least in a length section adjoining the associated gripper finger.

12. The gripping tool according to claim 1, wherein the leaf spring clips form at least one pair of spring clips consisting of two leaf spring clips lying opposite each other transversely to the center axis and in a common spring clip pair plane.

13. The gripping tool according to claim 12, wherein four leaf spring clips form two pairs of spring clips which are arranged in a crossover configuration with mutually perpendicular spring clip pair planes, each leaf spring clip being attached via its outer clip section to the gripper finger carrier and via its inner clip section to the drive element.

14. The gripping tool according to claim 1, wherein four leaf spring clips form two pairs of spring clips which are arranged in a side-by-side configuration with mutually parallel spring clip pair planes, each leaf spring clip being fastened via its outer clip section to the gripper finger carrier and via its inner clip section to the drive element, a single gripper finger being arranged jointly in each case on the leaf spring clips arranged next to one another.

15. The gripping tool according to claim 14, wherein each pair of spring clips present forms a spring clip unit firmly connected to one another at the inner clip sections of its two leaf spring clips, the spring clip unit being formed in one piece.

16. The gripping tool according to claim 15, wherein the leaf spring clips of each pair of spring clips have a common inner attachment end section.

17. The gripping tool according to claim 1, wherein the gripping tool has a base body in which a drive unit of the actuating device, which cooperates magnetically with the drive element to generate its drive movement, is accommodated.

18. The gripping tool according to claim 17, wherein the drive unit is designed to provide at least one magnetic field which can selectively exert magnetic drive forces on the drive element to cause the drive movement, or wherein the drive element has magnetizable properties and advantageously consists of a ferromagnetic material.

19. The gripping tool according to claim 18, wherein the drive unit contains a permanent magnet providing a permanent magnetic field and an electrically energizable coil, wherein a coil magnetic field superimposed on the permanent magnetic field can be generated by energizing the coil, by means of which the magnetic drive forces acting on the drive element can be influenced.

20. The gripping tool according to claim 19, wherein the gripper fingers can be positioned in a bistable manner either in a closed position closer to the center axis by the inward swivel movement or in an open position away from the center axis by the outward swivel movement, the open position with deactivated coil being stably retainable by the spring forces of the leaf spring clips and the closed position with deactivated coil being stably retainable by the permanent magnetic field, wherein the actuating device contains a switch-over device which enables the coil to be energized with opposing current directions, so that a coil magnetic field which weakens or strengthens the permanent magnetic field can be generated as desired in order to change over the gripper fingers between the open position and the closed position.

21. The gripping tool according to claim 17, wherein the gripper finger carrier is sleeve-shaped and belongs to a gripper unit which also contains the leaf spring clips and the gripper fingers and is separate with respect to the base body, which is placed on the base body with the sleeve-shaped gripper finger carrier in the axial direction of the center axis while assuming a position of use and is detachably fixed to the base body by a securing device.

22. The gripping tool according to claim 21, wherein the securing device is designed as a bayonet connection device in such a way that the gripper unit can be fixed to the base body as part of a plug-in rotary movement or wherein an identification ring is placed coaxially on the gripper finger carrier.

23. The gripping tool according to claim 1, wherein the drive element can be moved during its drive movement in the axial direction of the center axis between a front end position, which can be fixed by spring forces of the leaf spring clips, and a rear end position, which is opposite thereto, wherein a stop element, which provides the front end position of the drive element and which has damping properties, is arranged on the gripper finger carrier.

24. The gripping tool according to claim 1, wherein a guide element projecting away in the axial direction of the center axis is arranged on the gripper finger carrier in the region of a front side facing the gripper fingers, by means of which guide element the gripper fingers are supported orthogonally to a gripper finger swivel plane along which they move during the inward swivel movement or the outward swivel movement, and/or wherein an open guide recess on an inner side facing the center axis is formed in each gripper finger, into which guide recess the guide element with a guide extension dips.

25. The gripping tool according to claim 24, wherein the guide element has a basis section which is fixed to the gripper finger carrier and on which all the guide projections are arranged so as to project radially in the manner of wings or wherein the guide element is attached to the stop element.
